(19) United States
(12) Patent Application Publication
(10) Pub. No.: US 2021/0055708 A1
(43) Pub. Date: Feb. 25, 2021

(54) INFORMATION PROCESSING APPARATUS, INFORMATION PROCESSING METHOD, AND RECORDING MEDIUM FOR DETECTING AN ABNORMALITY OF A PROCESSING DEVICE THAT PROCESSES AN OBJECT

(71) Applicants: Masato HANDA, Tokyo (JP); Yasuhiro ONO, Tokyo (JP)

(72) Inventors: Masato HANDA, Tokyo (JP); Yasuhiro ONO, Tokyo (JP)

(21) Appl. No.: 16/957,655

(22) PCT Filed: Mar. 6, 2019
(86) PCT No.: PCT/JP2019/008951

§ 371 Date: Jun. 24, 2020

(30) Foreign Application Priority Data
Mar. 15, 2018 (JP) 2018-048384

(51) Int. Cl. G05B 19/4065

(52) U.S. Cl. CPC G05B 19/4065; G05B 2219/37434; G05B 2219/37245

(57) ABSTRACT

An information processing apparatus includes: a first acquisition unit configured to acquire detection information output from a detection unit; a second acquisition unit configured to acquire a signal indicating a section in which the target device operates; an extraction unit configured to extract characteristic information from the detection information; a data generation unit configured to calculate a processing section of each of the processing processes in the target device based on the signal, and classifies the detection information and the characteristic information; and an output control unit configured to output at least one of the signal of a section including the processing section, the detection information, and the characteristic information, and output at least one of the signal of sections including a plurality of processing sections of which cycles are different from each other, a plurality of the detection information, and a plurality of the characteristic information.

### TECHNICAL FIELD

The present invention relates to an information processing apparatus, an information processing method, and a recording medium.

### BACKGROUND ART

To detect an abnormality or the like of a processing device that processes an object to be processed, a method for detecting and outputting a physical amount such as information of a current value of a motor of a machine, vibration, or force is already known.

As a device that detects such a physical amount and detects an abnormality or the like of a tool, a device that outputs time series data of machine information such as a load of a main shaft and event data of a machining device in synchronization with each other, and detects an abnormality of the machining operation is known (see PTL 1).

### CITATION LIST

### Patent Literature

PTL 1: Japanese Unexamined Patent Application Publication No. 2017-033346

### SUMMARY OF INVENTION

### Technical Problem

However, according to the technique described in PTL 1, one can grasps the state of the machining device with machine information alone and cannot perform multifaceted evaluation.

The present invention has been made in view of the above-described problem, and an object of the present invention is to provide an information processing apparatus, an information processing method, and a recording medium that enable comparison of various types of information representing device states, and multifaceted evaluation.

### Solution to Problem

Example embodiments of the present invention include an information processing apparatus, which includes: a first acquisition unit configured to acquire detection information that is output from a detection unit that detects a physical amount that changes according to an operation of a target device that repeats a cycle including a plurality of processing processes; a second acquisition unit configured to acquire a signal indicating a section in which the target device operates from the target device; an extraction unit configured to extract characteristic information indicating a characteristic of the detection information from the detection information; a data generation unit configured to calculate a processing section of each of the processing processes in the target device based on the signal, and classify the detection information and the characteristic information for each of the processing processes; and an output control unit configured to output at least one of the signal of a section including the processing section, the detection information corresponding to the section including the processing section, and the characteristic information corresponding to the section including the processing section, and output at least one of the signal of sections including a plurality of processing sections of which cycles are different from each other, a plurality of pieces of the detection information respectively corresponding to the sections including the plurality of processing sections, and a plurality of pieces of the characteristic information respectively corresponding to the sections including the plurality of processing sections.

### Advantageous Effects of Invention

According to one or more embodiments of the present invention, various types of information representing device states can be compared, and multifaceted evaluation can be performed.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a block diagram illustrating an example of a functional configuration of a diagnostic system, according to an embodiment.

FIG. 2 is a diagram illustrating an example of a hardware configuration of a machining device, according to an embodiment.

FIG. 3 is a diagram illustrating an example of a hardware configuration of a diagnostic device, according to an embodiment.

FIG. 4 is a diagram illustrating examples of detection information and a ladder signal of the machining device, according to an embodiment.

FIG. 5 is a schematic diagram illustrating characteristic information extracted from detection information by the diagnostic device with a frequency component, according to an embodiment.

FIG. 6 is a diagram illustrating an example of a data information screen displayed by the diagnostic device, according to an embodiment.

FIG. 7 is a diagram illustrating another example of the data information screen displayed by the diagnostic device, according to an embodiment.

FIG. 8 is a diagram illustrating an example of a list screen displayed by the diagnostic device, according to an embodiment.

FIG. 9 is a diagram illustrating an example of a capture screen displayed by the diagnostic device, according to an embodiment.

FIG. 10 is a diagram illustrating an example of a history information screen displayed by the diagnostic device, according to an embodiment.

FIG. 11 is a flowchart illustrating an example of a process of data processing by the diagnostic device, according to an embodiment.

FIG. 12 is a flowchart illustrating an example of a process of data display processing by the diagnostic device, according to an embodiment.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

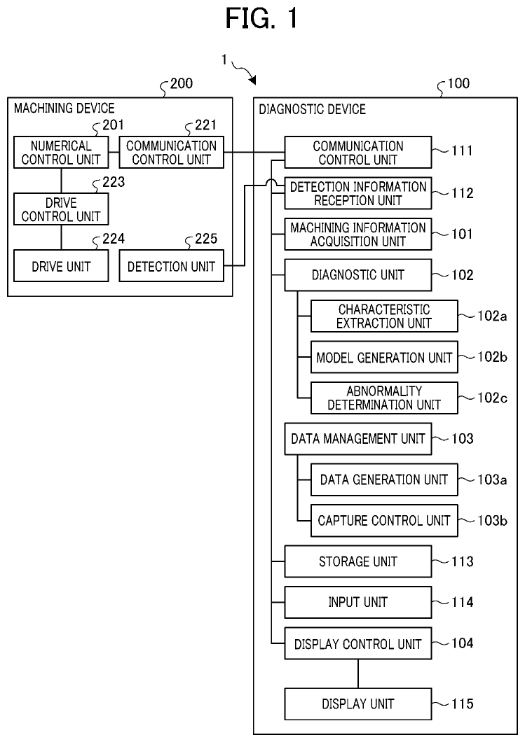

Hereinafter, embodiments of an information processing apparatus, an information processing method, and a recording medium according to the present invention will be described in detail with reference to FIGS. 1 to 12. The present invention is not limited by the following embodiments, and the constituent elements in the following embodiments include those easily conceivable by a person skilled in the art, those substantially the same, and those in a so-called range of equivalency. Furthermore, various omissions, substitutions, changes, and combinations of the constituent elements can be made without departing from the gist of the following embodiments.

Overview of Configuration of Diagnostic System 1:

FIG. 1 is a block diagram illustrating an example of an overview of a functional configuration a diagnostic system 1 according to an embodiment. A diagnostic device 100, which is an example of an information processing apparatus included in the diagnostic system 1, includes a detection information reception unit 112, which is an example of a first acquisition unit that acquires detection information output from a detection unit 225 that detects a physical amount that changes according to an operation of a machining device 200, which is an example of a target device that repeats a cycle including machining processes, which are an example of a plurality of processing processes. The diagnostic device 100 further includes a machining information acquisition unit 101, which is an example of a second acquisition unit that acquires a ladder signal, which is an example of a signal indicating a section in which the machining device 200 operates, from the machining device 200. The diagnostic device 100 further includes a characteristic extraction unit 102a, which is an example of an extraction unit that extracts characteristic information indicating a characteristic of the detection information from the detection information. The diagnostic device 100 further includes a data generation unit 103a that calculates a machining section, which is an example of a processing section, of each machining process in the machining device 200 based on the ladder signal, and classifies the detection information and the characteristic information for each machining process. The diagnostic device 100 further includes a display control unit 104, which is an example of an output control unit that outputs at least one of the ladder signal of a section including the machining section, detection information corresponding to a section including the machining section, and characteristic information corresponding to a section including the machining section, and outputs at least one of the ladder signals of a plurality of sections each including the machining section of which cycles are different, a plurality of pieces of detection information respectively corresponding to the sections each including the machining section, and a plurality of pieces of characteristic information respectively corresponding to the sections each including the machining section. Hereinafter, details of the diagnostic system 1 of the embodiment will be described.

As illustrated in FIG. 1, the diagnostic system 1 according to the embodiment includes the machining device 200 and the diagnostic device 100 connected to the machining device 200. The machining device 200 is a machine tool that performs processing such as cutting, grinding, or polishing on an object to be machined, using a tool. The machining device 200 is an example of the target device as an object to be diagnosed by the diagnostic device 100. The diagnostic device 100 is a device communicably connected to the machining device 200 and which diagnoses an abnormality regarding an operation of the machining device 200.

The machining device 200 includes a numerical control unit 201, a communication control unit 221, a drive control unit 223, a drive unit 224, and the detection unit 225.

The numerical control unit 201 is a functional unit that executes machining by the drive unit 224 by numerical control (NC). For example, the numerical control unit 201 generates and outputs numerical control data for controlling the operation of the drive unit 224. Further, the numerical control unit 201 outputs, to the communication control unit 221, a ladder signal that is an ON/OFF signal indicating a section (cutting feed section) from a feed operation of the tool to the object to be machined to the end of actual machining processing as context information (machining information) indicating an operation state of the drive unit 224 that drives the tool, for example. The context information is a plurality of pieces of information determined for each type of operation of the machining device 200. For example, the context information include, in addition to the above-described ladder signal, identification information of the machining device 200, identification information of the drive unit 224 (for example, tool identification information and the like), configuration information such as a diameter of the tool driven by the drive unit 224 and the material of the tool, and information of machining conditions such as the operation state of the drive unit 224, a cumulative operation time from the start of use of the drive unit 224, a load applied to the drive unit 224, a number of revolution of the drive unit 224, and a machining speed of the drive unit 224.

The numerical control unit 201 continuously transmits the context information corresponding to the current operation of the machining device 200 to the diagnostic device 100 via the communication control unit 221, for example. When machining the object to be machined, the numerical control unit 201 changes a type of the drive unit 224 to be driven or a driving state (the number of revolutions, a rotational speed, or the like) of the drive unit 224 according to a machining process. Each time changing the type of operation, the numerical control unit 201 sequentially transmits the context information corresponding to the changed type of operation to the diagnostic device 100 via the communication control unit 221.

The communication control unit 221 is a functional unit that controls communication with an external device such as the diagnostic device 100. The communication control unit 221 transmits the context information corresponding to the current operation to the diagnostic device 100, for example.

The drive control unit 223 is a functional unit that controls the driving of the drive unit 224 on the basis of the numerical control data obtained by the numerical control unit 201.

The drive unit 224 is a functional unit, driving of which is controlled by the drive control unit 223. The drive unit 224 drives the tool under the control of the drive control unit 223. The drive unit 224 is an actuator (motor) or the like, driving of which is controlled by the drive control unit 223. The drive unit 224 can be any types of actuator, provided that the actuator is used for machining and can be an object to be numerically controlled. Further, two or more drive units 224 can be provided.

The detection unit 225 is a functional unit that detects a physical amount generated by the machining device 200 and outputs information of the detected physical amount to the diagnostic device 100 as detection information (sensor data). The physical amount generated in the machining device 200 is vibration, sound, or the like generated in the machining device 200. Such vibration, sound, or the like is generated when, for example, a tool placed in the machining device 200 comes in contact with the object to be machined during the machining operation. Alternatively, such vibration, sound or the like is emitted by the tool or the machining device 200. Any suitable number of detection units 225 can be provided. For example, a plurality of the detection units 225 that detects the same physical amount can be provided, or a plurality of the detection units 225 that detects physical amounts different from one another can be provided. For example, when breakage and chipping of a blade that is a tool used for machining occur, vibration and sound during machining change. For this reason, the detection unit 225 detects vibration data and acoustic data and makes determination using a model or the like for determining normal vibration and sound, thereby detecting an abnormality of the operation of the machining device 200.

The diagnostic device 100, which is an example of the information processing apparatus, includes a communication control unit 111, the detection information reception unit 112, the machining information acquisition unit 101, a diagnostic unit 102, a data management unit 103, a storage unit 113, an input unit 114, the display control unit 104, and a display unit 115.

The communication control unit 111 is a functional unit that controls communication with the machining device 200. For example, the communication control unit 111 receives the context information from the numerical control unit 201 of the machining device 200 via the communication control unit 221.

The detection information reception unit 112, which is an example of the first acquisition unit, is a functional unit that receives the detection information from the detection unit 225 provided in the machining device 200.

The machining information acquisition unit 101, which is an example of the second acquisition unit, is a functional unit that acquires the context information (machining information) received by the communication control unit 111 from the machining device 200.

The diagnostic unit 102 is a functional unit that includes the characteristic extraction unit 102a, a model generation unit 102b, and an abnormality determination unit 102c, and determines an abnormality or the like of the operation of the machining device 200.

The characteristic extraction unit 102a, which is an example of the extraction unit, is a functional unit that extracts the characteristic information to be used for determination by the abnormality determination unit 102c from the detection information. The characteristic information can be any information provided that the information indicates a characteristic of the detection information.

The model generation unit 102b is a functional unit that generates a model used for determining whether machining has been normally performed. The model is generated for each piece of the context information, for example. In a case where a model is generated by extraneous sources, the model generation unit 102b can be omitted.

The abnormality determination unit 102c is a functional unit that determines whether the operation of the machining device 200 is normal, using the characteristic information extracted by the characteristic extraction unit 102a and the model for each piece of the context information generated by the model generation unit 102b.

The data management unit 103 is a functional unit that includes the data generation unit 103a and a capture control unit 103b, and processes and manages the detection information, the context information, the characteristic information, and the like.

The data generation unit 103a calculates the machining section, which is an example of a processing process, of each machining process, in the machining device 200 based on the context information. Further, the data generation unit 103a divides the detection information acquired by the detection information reception unit 112 and the characteristic information extracted by the characteristic extraction unit 102a for each machining process.

The capture control unit 103b, which is an example of a data recording control unit, is a functional unit that enables recording of display data of the display unit 115 connected to the display control unit 104 at desired timing.

The storage unit 113 is a functional unit that stores the detection information acquired by the detection information reception unit 112 in association with the context information. Further, the storage unit 113 stores the characteristic information extracted by the characteristic extraction unit 102a in association with the context information. Further, the storage unit 113 stores the model generated by the model generation unit 102b in association with the context information.

The input unit 114 is a functional unit that performs operations such as input of letters and numbers, selection of various instructions, and movement of a cursor.

The display control unit 104, which is an example of the output control unit, is a functional unit that controls a display operation of the display unit 115. Specifically, the display control unit 104 causes the display unit 115 to display, for example, a result of abnormality determination by the abnormality determination unit 102c. In addition, the display control unit 104 causes the display unit 115 to display data processed by the data management unit 103. The display unit 115 is a functional unit that displays various types of information under the control of the display control unit 104.

The functional units of the diagnostic device 100 and the machining device 200 are conceptual representations of the functions, and are not limited to such configurations. For example, the plurality of functional units illustrated as independent functional units in FIG. 1 can be configured as one functional unit. By contrast, the function of one functional unit in FIG. 1 can be divided into a plurality of functional units.

Further, the machining device 200 and the diagnostic device 100 can be connected in any form of connection. For example, the machining device 200 and the diagnostic device 100 is connected via a dedicated connection line, a wired network such as a wired local area network (LAN), or a wireless network.

Although FIG. 1 illustrates an example in which one machining device 200 is connected to the diagnostic device 100, the embodiment is not limited to the example, and a plurality of the machining devices 200 can be communicably connected to the diagnostic device 100.

Hardware Configuration of Machining Device 200:

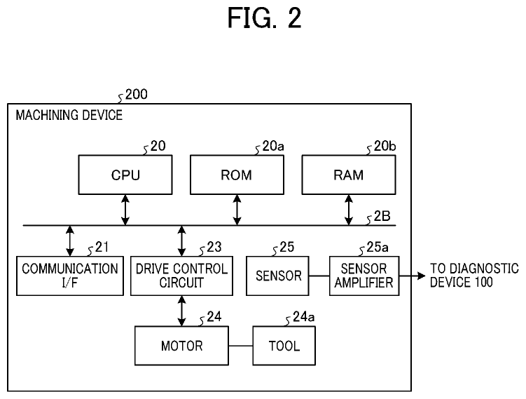

Next, an example of a hardware configuration of the machining device 200 according to the embodiment will be described with reference to FIG. 2. FIG. 2 is a diagram illustrating an example of a hardware configuration of the machining device 200 according to the embodiment.

As illustrated in FIG. 2, the machining device 200 includes a central processing unit (CPU) 20, a read only memory (ROM) 20a, a random access memory (RAM) 20b, a communication interface (I/F) 21, and a drive control circuit 23 that are communicably connected by a bus 2B.

The CPU 20 is an arithmetic device that controls entire operation of the machining device 200. The CPU 20 executes a program stored in the ROM 20a or the like using the RAM 20b as a work area, for example, thereby controlling the entire operation of the machining device 200 to implement a machining function. The numerical control unit 201 in FIG. 1 is implemented by, for example, the program operating on the CPU 20.

The communication I/F 21 is an interface used for communication with an external device such as the diagnostic device 100. The communication I/F 21 is, for example, a network internet card (NIC) compatible with transmission control protocol (TCP)/internet protocol (IP). The communication control unit 221 in FIG. 1 is implemented by, for example, the communication I/F 21 and the program operating on the CPU 20.

The drive control circuit 23 is a circuit that controls driving of a motor 24. The motor 24 drives a tool 24a used for machining. The tool 24a includes a drill, an end mill, a cutting tip, a grinding stone, or the like, and a table on which the object to be machined is placed and moved in accordance with the machining. The drive control unit 223 in FIG. 1 is implemented by the drive control circuit 23, for example. The drive unit 224 in FIG. 1 is implemented by the motor 24, for example.

A sensor 25 is implemented by, for example, a microphone device, a vibration sensor, an acceleration sensor, an acoustic emission (AE) sensor, or the like, and is provided near the tool of which vibration, sound, or the like can be detected. A sensor amplifier 25a to which the sensor 25 is connected is communicably connected to the diagnostic device 100. In one example, the sensor 25 and the sensor amplifier 25a are provided in advance in the machining device 200. In another example, the sensor 25 and the sensor amplifier 25a are attached to the machining device 200 after the machining device is manufactured. Further, the sensor amplifier 25a is not limited to being provided in the machining device 200. In another example, the sensor amplifier is provided in the diagnostic device 100. The detection unit 225 in FIG. 1 is implemented by, for example, the sensor 25 and the sensor amplifier 25a.

The hardware configuration illustrated in FIG. 2 is an example, and the machining device 200 does not need to have all the constituent devices and may have another constituent device. For example, the numerical control unit 201 and the communication control unit 221 illustrated in FIG. 1 can be implemented by causing the CPU 20 illustrated in FIG. 2 to execute a program, that is, implemented by software. In another example, the numerical control unit 201 and the communication control unit 221 are implemented by hardware such as an integrated circuit (IC). In still another example, the numerical control unit 201 and the communication control unit 221 are implemented using software and hardware in combination.

Hardware Configuration of Diagnostic Device 100:

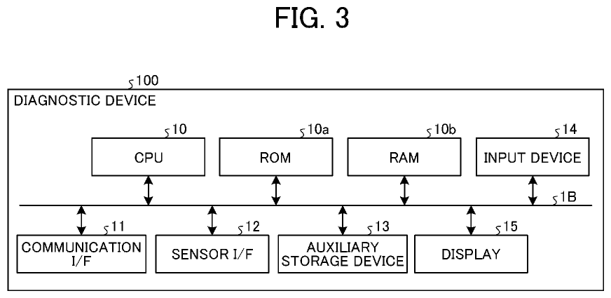

Next, an example of a hardware configuration of the diagnostic device 100 of the embodiment will be described with reference to FIG. 3. FIG. 3 is a diagram illustrating an example of a hardware configuration of the diagnostic device 100 according to the embodiment.

As illustrated in FIG. 3, the diagnostic device 100 includes a CPU 10, a ROM 10a, a RAM 10b, a communication I/F 11, a sensor I/F 12, an auxiliary storage device 13, an input device 14, and a display 15 that are communicably connected by a bus 1B.

The CPU 10 is an arithmetic device that controls entire operation of the diagnostic device 100. The CPU 10 executes a program stored in the ROM 10a or the like using the RAM 10b as a work area, for example, thereby controlling entire operation of the diagnostic device 100 to implement a diagnostic function. The machining information acquisition unit 101, the diagnostic unit 102, the data management unit 103, and the display control unit 104 in FIG. 1 are implemented by, for example, the program operating on the CPU 10.

The communication I/F 11 is an interface used for communication with an external device such as the machining device 200. The communication I/F 11 is, for example, a NIC or the like compatible with TCP/IP. The communication control unit 111 in FIG. 1 is implemented by, for example, the communication I/F 11 illustrated in FIG. 3 and the program operating on the CPU 10.

The sensor I/F 12 is an interface that receives the detection information from the sensor 25 provided in the machining device 200 via the sensor amplifier 25a. The detection information reception unit 112 in FIG. 1 is implemented by, for example, the sensor I/F 12 and the program operating on the CPU 10.

The auxiliary storage device 13 includes a non-volatile storage device such as a hard disk drive (HDD), a solid state drive (SSD), or an electrically erasable programmable read-only memory (EEPROM) that stores setting information of the diagnostic device 100, the detection information and the context information received from the machining device 200, an operating system (OS), and various data such as application programs. Although the auxiliary storage device 13 is provided in the diagnostic device 100, the embodiment is not limited to the example. In another example, the auxiliary storage device 13 is a storage device provided outside the diagnostic device 100. In still another example, the auxiliary storage device is a storage device included in a server device that can perform data communication with the diagnostic device 100. The storage unit 113 in FIG. 1 is implemented by, for example, the RAM 10b and the auxiliary storage device 13.

The input device 14 is an input device such as a mouse or a keyboard for performing operations such as input of letters and numbers, selection of various instructions, and movement of a cursor. The input unit 114 in FIG. 1 is implemented by, for example, the input device 14.

The display 15 is a display device such as a cathode ray tube (CRT) display, a liquid crystal display (LCD), or an organic electro-luminescence (EL) display that displays letters, numbers, various screens and operation icons, and the like. The display unit 115 in FIG. 1 is implemented by, for example, the display 15.

The hardware configuration illustrated in FIG. 3 is an example, and the diagnostic device 100 does not need to have all the constituent devices and may have another constituent device. For example, the functional units (the machining information acquisition unit 101, the diagnostic unit 102, the data management unit 103, and the display control unit 104) of the diagnostic device 100 illustrated in FIG. 1 are implemented by causing the CPU 10 to execute a program, that is, by software. In another example, the functional units (the machining information acquisition unit 101, the diagnostic unit 102, the data management unit 103, and the display control unit 104) of the diagnostic device 100 are implemented by hardware such as an IC. In still another example, the functional units (the machining information acquisition unit 101, the diagnostic unit 102, the data management unit 103, and the display control unit 104) of the diagnostic device 100 are implemented using software and hardware in combination. Further, in a case where the diagnostic device 100 is dedicated to a diagnostic operation of the machining device 200 and transmits a diagnostic result to an external server device or the like, the diagnostic device 100 does not need to include the input device 14 and the display 15.

Operation Example of Data Management Unit 103:

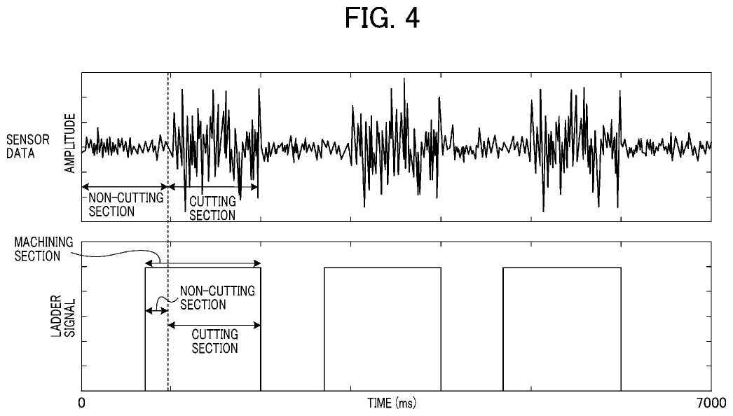

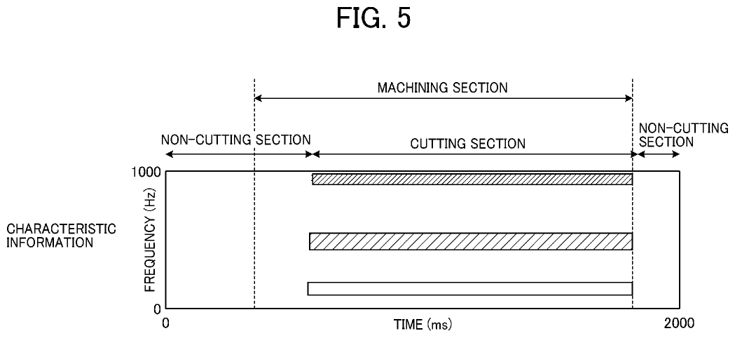

Next, an example of an operation example of the data management unit 103 will be described with reference to FIGS. 4 and 5.

In a case of manufacturing a plurality of predetermined machined products, the machining device 200 repeatedly performs a cycle including a plurality of machining processes in some cases. The data generation unit 103a of the data management unit 103 calculates a machining section and the like of each machining process based on the ladder signal and the like included in the context information.

FIG. 4 is a diagram illustrating examples of the detection information and the ladder signal of the machining device 200 according to the embodiment. As illustrated in FIG. 4, the sensor data (detection information) includes a waveform portion indicating a non-cutting section and another waveform portion indicating a cutting section. The non-cutting section is a section before and after the tool is in contact with the object to be machined. The cutting section is a section in which the tool performs cutting processing as being in contact with the object to be machined.

Meanwhile, the machining device 200 turns the ladder signal ON at the start of the machining operation with the tool, feeds the tool to the object to be machined, and turns the ladder signal OFF when the actual machining processing is completed. This means that the machining device 200 does not turn the ladder signal ON after the tool comes in contact with the object to be machined. For this reason, the machining section, which is a section in which the ladder signal is in the ON state in FIG. 4, includes the non-cutting section in which the tool is not in contact with the object to be machined and the cutting section in which the tool performs cutting processing in contact with the object to be machined.

The data generation unit 103a obtains, for each machining process, the cutting section in which the cutting processing is actually performed and the machining section including the non-cutting section, and calculates a machining time and a cutting time, respectively. The data generation unit 103a obtains the section in which the ladder signal is ON as the machining section and calculates the machining time. In calculating the cutting section, the data generation unit 103a refers to a characteristic amount extracted by the characteristic extraction unit 102a of the diagnostic unit 102.

In a case where the detection information is frequency data collected by a vibration sensor or a microphone device, for example, the characteristic extraction unit 102a extracts energy, a frequency spectrum, mel-frequency cepstrum coefficients (MFCC), and the like as the characteristic information. In the present embodiment, description will be given on the assumption that the characteristic information to be extracted is the frequency spectrum.

FIG. 5 is a diagram schematically illustrating characteristic information extracted from detection information by the diagnostic device 100 according to the embodiment with a frequency component. The section illustrated in FIG. 5 includes one machining section. That is, the section of FIG. 5 includes one cutting section.

For example, the characteristic extraction unit 102a performs Fourier transform for the detection information for each frame to extract the characteristic information. Here, the frame indicates a data amount of a predetermined time (for example, 20 [ms], 40 [ms], or the like) of the detection information, and corresponds to a data amount of a window length in a case where the characteristic information is the frequency spectrum obtained by performing Fourier transform for the detection information. The characteristic information illustrated in FIG. 5 is associated with a frame time of the corresponding detection information. The frequency spectrum of the cutting section has a characteristic different from a frequency spectrum of the non-cutting section. The data generation unit 103a calculates the cutting section from the difference between the frequency spectrums and calculates the cutting time.

Although FIG. 5 does not illustrate a frequency component in the non-cutting section in order to schematically illustrate the difference between the characteristic information of the non-cutting section and the characteristic information of the cutting section, this does not mean that there is no frequency component in the non-cutting section.

The machining section and the cut section calculated in this way correspond to one machining process in the cycle including a plurality of machining processes. The data generation unit 103a calculates the machining section and the cutting section for each of the plurality of machining processes included in the cycle, and calculates the respective times. Further, the data generation unit 103a classifies, for each of the machining processes, the ladder signal acquired by the machining information acquisition unit 101, the detection information received by the detection information reception unit 112, and the characteristic information extracted by the characteristic extraction unit 102a.

The classified detection information and characteristic information are stored in the storage unit 113 in association with the ladder signal of the corresponding machining section. These detection information and characteristic information are accumulated in the storage unit 113 as the machining device 200 repeats the above machining cycle.

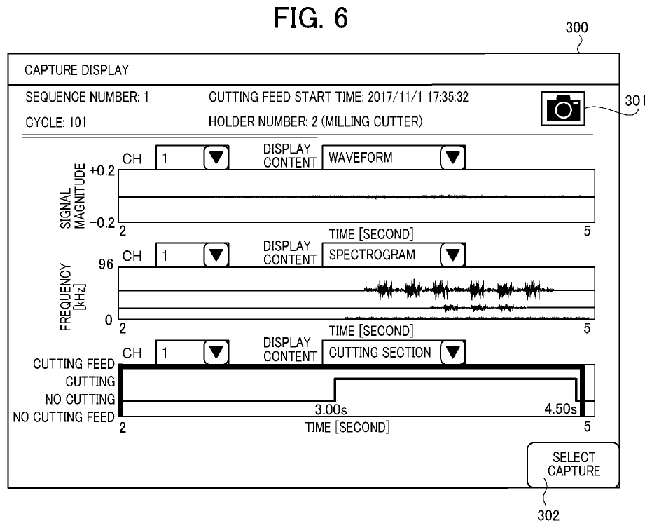

Operation Examples of Data Management Unit 103 and Display Control Unit 104: Next, examples of operations of the data management unit 103 and the display control unit 104 will be described with reference to FIGS. 6 to 10. In the following description, a screen operation by a user of the diagnostic device 100 is performed from the input unit 114 of the diagnostic device 100, for example. In another example, the display unit 115 of the diagnostic device can be a touch panel-type display, and the screen operation can be performed by the user by touching the display unit 115.

The display control unit 104 causes the display unit 115 to display at least one of the detection information, the characteristic information, and the ladder signal classified for each of the machining processes.

FIG. 6 is a diagram illustrating an example of a data information screen 300 displayed by the diagnostic device 100 according to the embodiment. In the example of FIG. 6, the display control unit 104 displays the detection information, the characteristic information, and the ladder signal, as the data information screen 300.

The data information screen 300 includes at least one type of time series data of the detection information, the characteristic information, and the ladder signal acquired in a certain machining process. The display section of each data is the machining section and sections before and after the machining section, the sections having a predetermined length, which is determined by a designer or a user, for example. In other words, the display section of each data is a section from a machining start time when the ladder signal is turned ON to a machining end time when the ladder signal is turned OFF, and a predetermined section before the machining start time and a predetermined section after the machining end time.

The user of the diagnostic device 100 can obtain various types of information from these data. For example, the user recognizes that the machining start time is 3.00 seconds and the machining end time is 4.50 seconds based on the ladder signal. The user also recognizes an overview of a machining state based on the detection information. The user recognizes that there is a section in which the waveform of the detection information is large within the machining section indicated by the ladder signal, and this section is the cutting section in which the cutting processing has been actually performed. The user recognizes, at the first glance, the cutting processing has been performed without any problem. The user recognizes details of the machining state and the characteristic based on the characteristic information. According to the characteristic information, strong frequency components in middle and low frequency regions are found in a certain section. This suggests a possibility of occurrence of a phenomenon different from a usual phenomenon, which cannot be obtained from the detection information.

The data information screen 300 further includes a capture button 301 and a capture selection button 302. The capture button 301 is a button used when the user captures the currently displayed screen. The capture selection button 302 is a button used for calling a previously captured screen on the currently displayed screen.

When the capture button 301 is pressed by the user, the capture control unit 103b causes the storage unit 113 to store the currently displayed screen in association with the context information corresponding to the data displayed on the screen. In the embodiment, it is assumed that the capture button 301 is pressed by the user and the currently displayed screen is captured.

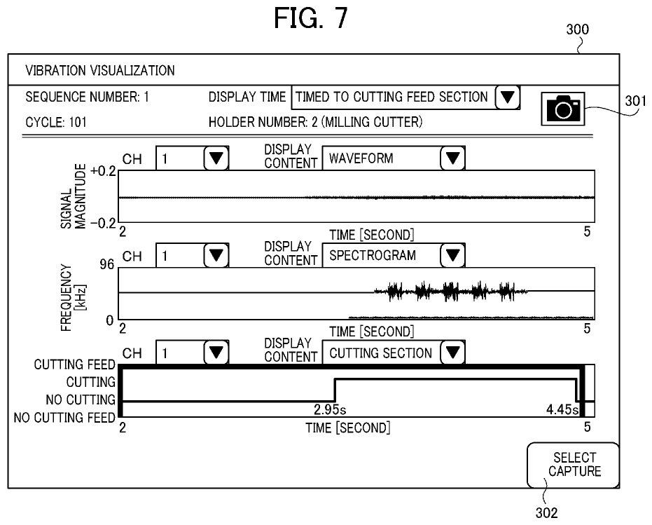

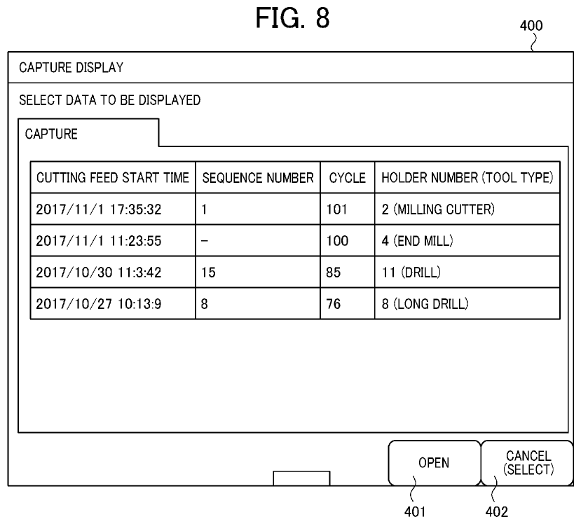

FIG. 7 is a diagram illustrating another example of the data information screen 300 displayed by the diagnostic device 100 according to the embodiment. When the capture selection button 302 is pressed by the user on this screen, the capture control unit 103b displays a list screen 400 illustrated in FIG. 8 on the display unit 115 via the display control unit 104.

FIG. 8 is a diagram illustrating an example of the list screen 400 displayed by the diagnostic device 100 according to the embodiment. As illustrated in FIG. 8, the list screen 400 includes a list of data captured until the current time. The list includes a cutting feed start time indicating the machining section, a sequence number indicating the machining process, the number of the cycle, a holder number indicating the type of the tool used, and the like. The user can select previously captured data from these pieces of information. That is, when an open button 401 included in the list screen 400 is pressed, the data captured previously is called, for example. When the cancel button 402 included in the list screen 400 is pressed, calling of the data is canceled and the screen is returned to the screen illustrated in FIG. 7.

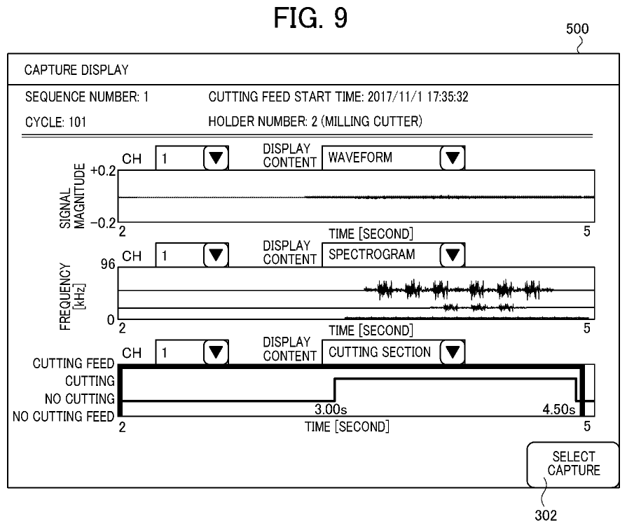

FIG. 9 is a diagram illustrating an example of a capture screen 500 called by the diagnostic device 100 according to the embodiment. By performing a series of operation from the screen of FIG. 7, the capture screen 500 of the data captured previously is called as illustrated in FIG. 9. The capture screen 500 also includes the capture selection button 302 that allows a user to call another data.

Further, the display control unit 104 causes the display unit 115 to display at least one of a plurality of pieces of the detection information, a plurality of pieces of the characteristic information, and a plurality of the ladder signals of different cycles.

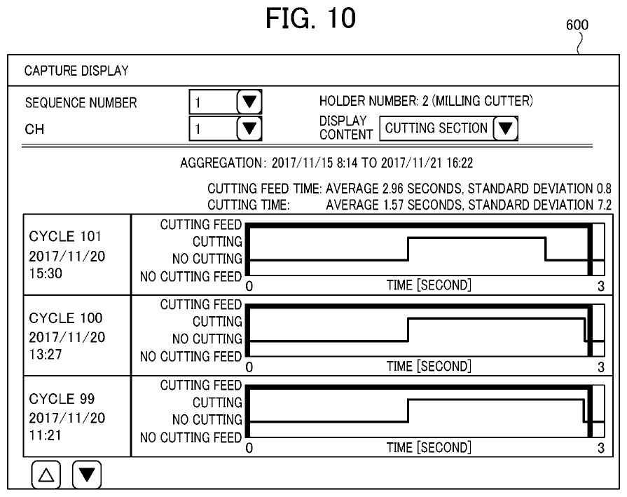

FIG. 10 is a diagram illustrating an example of a history information screen 600 displayed by the diagnostic device 100 according to the embodiment. In the example of FIG. 10, the display control unit 104 displays three types of data of cycles 99 to 101 regarding the ladder signal as the history information screen 600.

The history information screen 600 includes at least one type of time series data of the detection information, the characteristic information, and the ladder signals acquired in the plurality of cycles in a certain machining process. The display section of each data is the machining section and sections before and after the machining section, the sections having a predetermined length. In the example of FIG. 10 displaying the time series data of the ladder signal, data related to the ladder signal, that is, an average value and a standard deviation of the cutting feed times indicating the machining time, and an average value and a standard deviation of the cutting times are displayed. These statistical values are calculated by the data generation unit 103a.

The user can specify the sequence number indicating the machining process, the number of the cycle to be displayed, and the like, to display the history information screen 600. The user can obtain various types of information from these data. For example, in the example of FIG. 10, the standard deviation of the cutting time is 7.2, which indicates that the cutting time varies. In fact, looking at the data of the cycle 101, the cutting time is shorter than other data. This suggests that securement of the object to be machined was insufficient in the machining of the cycle 101. If the securement is insufficient, the object to be machined will move due to vibrations or the like during the machining. If the object to be machined moves, the tool does not come in contact with the object to be machined, and the machining can be judged as being although the machining is still underway. This shortens the cutting time.

Example of Information Processing of Diagnostic Device 100:

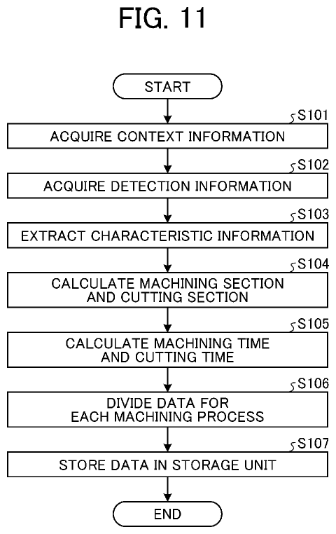

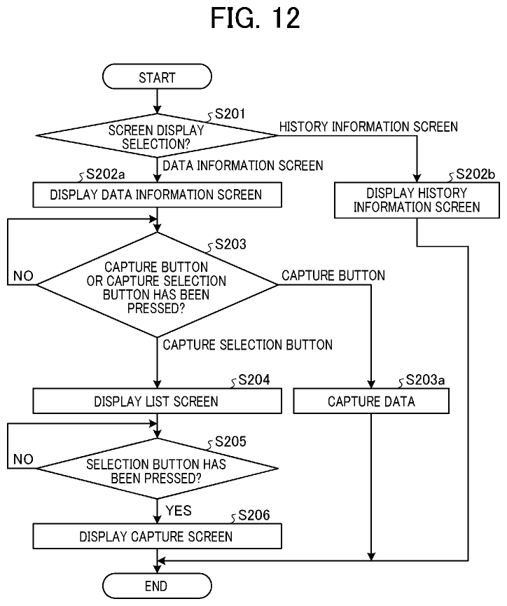

Next, an example of information processing by the diagnostic device 100 will be described with reference to FIGS. 11 and 12. The information processing by the diagnostic device 100 includes data processing by the diagnostic device 100 and data display processing by the diagnostic device 100. FIG. 11 is a flowchart illustrating an example of a procedure of data processing of the diagnostic device 100 according to the embodiment.

As illustrated in FIG. 11, in step S101, the machining information acquisition unit 101 acquires the context information from the machining device 200. In step S102, the detection information reception unit 112 receives the detection information from the detection unit 225.

In step S103, the characteristic extraction unit 102a extracts the characteristic information from the received detection information.

In step S104, the data generation unit 103a calculates the machining section and the cutting section from the acquired context information. In step S105, the data generation unit 103a calculates the respective times of the calculated machining section and cutting section. In step S106, the data generation unit 103a classifies the detection information, the characteristic information, and the ladder signal for each machining process on the basis of the calculated machining section.

In step S104, the detection information and the characteristic information classified for each machining process are stored in the storage unit 113 in association with the ladder signal of the corresponding machining section.

Thus, the data processing by the diagnostic device 100 is completed.

Next, an example of data display processing by the diagnostic device 100 will be described with reference to FIG. 12. FIG. 12 is a flowchart illustrating an example of a procedure of data display processing of the diagnostic device 100 according to the embodiment.

As illustrated in FIG. 12, in step S201, the screen display of either the data information screen 300 or the history information screen 600 is selected on a given screen. In the case where the screen display of the history information screen 600 is selected, in step S202b, the display control unit 104 of the diagnostic device 100 causes the display unit 115 to display the history information screen 600.

In the case where the screen display of the data information screen 300 is selected, in step S202a, the display control unit 104 causes the display unit 115 to display the data information screen 300.

In step S203, the capture control unit 103b determines whether the capture button 301 or the capture selection button 302 is pressed. In the case where the capture button 301 is pressed, in step S203a, the capture control unit 103b stores the data of the data information screen 300 in the storage unit 113 in association with the corresponding context information.

In the case where the capture selection button 302 is pressed, in step S204, the display control unit 104 causes the display unit 115 to display the list screen 400. In step S205, the display control unit 104 determines whether the open button 401 is pressed. In the case where the open button 401 is pressed, in step S206, the display control unit 104 causes the display unit 115 to display the capture screen 500.

Thus, the data display processing by the diagnostic device 100 is completed.

The information acquisition device of PTL 1 outputs the time series data of mechanical information such as a main shaft load and the event data of the device such as a program name, a tool number, and an override value by an operator operation in association with each other, for example. As a result, the information acquisition device detects the abnormality of the machining operation. However, grasping the state of the machining device with the machine information alone does not enable multifaceted and sufficient evaluation.

In the diagnostic device 100 of the embodiment, the data generation unit 103a classifies the detection information, the characteristic information, and the ladder signal for each machining process, and the display control unit 104 displays these data. By comparing the various data in this way, the user can grasp and evaluate the state of the machining device 200 in a multifaceted manner.

In the diagnostic device 100 of the embodiment, the data processed by the data generation unit 103a is accumulated in the storage unit 113 and is displayed as the history information screen 600 by the display control unit 104. This allows the user to compare the displayed data of different cycles, thereby grasping and evaluating chronological change of the machining device 200.

In the diagnostic device 100 of the embodiment, the statistical data such as the average value and the standard deviation is displayed on the history information screen 600. This allows the user to perform the evaluation in a more multifaceted and quantitative manner.

In the diagnostic device 100 of the embodiment, the data can be stored by the capture control unit 103b at desired timing and can be referred to later. This allows the user to refer to the data when the user needs the data and to obtain the data with simple operation. The user can easily notice a small change that may be a cause of abnormality of the machining device 200.

In the diagnostic device 100 of the embodiment, the time series data displayed by the display control unit 104 is displayed including the sections before and after the machining section. This makes it easy for a user to recognize the degree of contact of the tool with the object to be machined and the state when the tool is detached from the object to be machined.

Variations:

In the above-described embodiment, the display control unit 104 of the diagnostic device 100 causes the display unit 115 to display various data. However, the data output method is not limited to the embodiment. In another example, the various data can be printed out by a printer or the like connected to the diagnostic device 100.

In the above-described embodiment, the detection information is the vibration data, acoustic data, or the like. However, any other suitable data such as a current value, a load, and torque of the motor can be used as the detection information.

In the above-described embodiment, the device to be diagnosed is the machining device 200, for example. In another example, any other suitable machine such as an assembling machine, a measuring machine, an inspecting machine, or a cleaning machine can be the target device.

The programs executed by the diagnostic system of the above-described embodiment and variations can be provided by being stored in a ROM or the like in advance.

Further, the programs executed by the diagnostic system of the above-described embodiment and variations may be recorded in a computer-readable recording medium such as a compact disk read only memory (CD-ROM), a flexible disk (FD), a compact disk-recordable (CD-R), or a digital versatile disk (DVD) in an installable or executable-format file and provided as a computer program product.

Further, the programs executed by the diagnostic system of the above-described embodiment and variations can be stored in a computer connected to a network such as the Internet and provided by being downloaded via the network. Further, the programs executed by the diagnostic system of the above-described embodiment and variations can be provided or distributed via the network such as the Internet.

Further, the programs executed by the diagnostic system of the above-described embodiment and variations have a module configuration having the above-describe functional units, and as actual hardware, the CPU (processor) reads the program from the ROM and executes the program, so that the functional units are loaded on the main storage device and generated on the main storage device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The present invention can be implemented in any convenient form, for example using dedicated hardware, or a mixture of dedicated hardware and software. The present invention may be implemented as computer software implemented by one or more networked processing apparatuses. The processing apparatuses can include any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can include a transient carrier medium such as an electrical, optical, microwave, acoustic or radio frequency signal carrying the computer code. An example of such a transient medium is a TCP/IP signal carrying computer code over an IP network, such as the Internet. The carrier medium can also include a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority pursuant to 35 U.S.C. § 119(a) to Japanese Patent Application No. 2018-048384, filed on Mar. 15, 2018 in the Japan Patent Office, the entire disclosure of which is hereby incorporated by reference herein.

### REFERENCE SIGNS LIST

1 Diagnostic System
1B Bus
10 CPU
10a ROM
10b RAM
11 Communication I/F
12 Sensor I/F
13 Auxiliary Storage Device
14 Input Device
15 Display
2B Bus
20 CPU
20a ROM
20b RAM
21 Communication I/F
23 Drive Control Circuit
24 Motor
24a Tool
25 Sensor
25a Sensor Amplifier
100 Diagnostic Device
111 Communication Control Unit
112 Detection Information Reception Unit
101 Machining Information Acquisition Unit
102 Diagnostic Unit
102a Characteristic Extraction Unit
103 Data Management Unit
103a Data Generation Unit
103b Capture Control Unit
104 Display Control Unit
113 Storage Unit
114 Input Unit
115 Display Unit
200 Machining Device
201 Numerical Control Unit
221 Communication Control Unit
223 Drive Control Unit
224 Drive Unit
225 Detection Unit

1. An information processing apparatus, comprising:
circuitry configured to
acquire detection information that is output from a detector that detects a physical amount that changes according to an operation of a target device that repeats a cycle including a plurality of processing processes;
acquire a signal indicating a section in which the target device operates, from the target device;
extract characteristic information indicating a characteristic of the detection information from the detection information;
calculate a processing section of each of the processing processes in the target device based on the signal, and classify the detection information and the characteristic information for each of the processing processes; and
output at least one of the signal of a section including the processing section, the detection information corresponding to the section including the processing section, and the characteristic information corresponding to the section including the processing section, and output at least one of the signal of sections including a plurality of processing sections of which cycles are different from each other, a plurality of pieces of the detection information respectively corresponding to the sections including the plurality of processing sections, and a plurality of pieces of the characteristic information respectively corresponding to the sections including the plurality of processing sections.

2. The information processing apparatus according to claim 1, wherein
the section including the processing section is a section that includes a section from a processing start time to a processing end time and a predetermined section after the processing end time.

3. The information processing apparatus according to claim 1, further comprising:
a display configured to display at least one of the signal of the section including the processing section, the detection information corresponding to the section including the processing section, and the characteristic information corresponding to the section including the processing section, wherein
the circuitry is further configured to allow a user to store display data at desired timing on a screen displayed on the display, and
the circuitry is further configured to cause the display to display a list of a plurality of data stored in accordance with an operation by the user, and output data selected from the list of the plurality of data.

4. The information processing apparatus according to claim 3, wherein
the circuitry is further configured to cause the display to switch display among the screen displayed on the display, a screen displaying the display data stored in accordance with the operation by the user at the desired timing, and a history information screen displaying the signal of the sections including the plurality of processing sections of which cycles are different from each other, via a list screen displaying the list of the plurality of data.

5. The information processing apparatus according to claim 1, wherein
the circuitry is further configured to calculate a processing time of each of the plurality of processing sections of which cycles are different from each other, and calculate a statistical value of a plurality of the calculated processing times.

6. The information processing apparatus according to claim 5, wherein the circuitry is further configured to output the statistical value of the plurality of processing times.

7. (canceled)

8. A non-transitory computer-readable recording medium for storing a computer-readable program that causes a computer to execute:
acquiring detection information that is output from a detection unit that detects a physical amount that changes according to an operation of a target device that repeats a cycle including a plurality of processing processes;
acquiring a signal indicating a section in which the target device is operated from the target device;
extracting characteristic information indicating a characteristic of the detection information from the detection information;
calculating a processing section of each of the processing processes in the target device based on the signal;
classifying the detection information and the characteristic information for each of the processing processes; and
outputting at least one of the signal of a section including the processing section, the detection information corresponding to the section including the processing section, and the characteristic information corresponding to the section including the processing section, and outputting at least one of the signal of sections including a plurality of processing sections of which cycles are different from each other, a plurality of pieces of the detection information respectively corresponding to the sections including the plurality of processing sections, and a plurality of pieces of the characteristic information respectively corresponding to the sections including the plurality of processing sections.

9. An information processing apparatus, comprising:
circuitry configured to
acquire detection information that is output from a detector that detects a physical amount that changes according to an operation of a target device that repeats a cycle including a plurality of processing processes;
acquire a signal indicating a section in which the target device operates from the target device;
classify, for each of the processing processes, the detection information and characteristic information indicating a characteristic of the detection information extracted from the detection information, based on a processing section of each of the processing processes in the target device calculated based on the signal; and
switch display of at least one of the signal of section including a plurality of processing sections of which cycles are different from each other, a plurality of pieces of the detection information respectively corresponding to the sections including the plurality of processing sections, and a plurality of pieces of the characteristic information respectively corresponding to the sections including the plurality of the processing sections.
